(19) United States
(12) Patent Application Publication
(10) Pub. No.: US 2014/0233040 A1
(43) Pub. Date: Aug. 21, 2014

(54) Methods and Devices for Measuring Homogeneously Reflective Surfaces

(71) Applicant: SIEMENS AKTIENGESELLSCHAFT, Munchen (DE)

(72) Inventors: Werner Gergen, Aschheim (DE); Detlef Gerhard, Munchen (DE); Martin Weber, Markt Schwaben (DE)

(21) Appl. No.: 14/347,199

(22) PCT Filed: Sep. 3, 2012
(86) PCT No.: PCT/EP2012/067113

§ 371 Date: Mar. 25, 2014

(30) Foreign Application Priority Data
Sep. 26, 2011 (DE) 102011083421.4

(51) Int. Cl. G01B 11/22

(52) U.S. Cl. CPC G01B 11/22
USPC 356/609

(57) ABSTRACT

A focal point generated by a confocal sensor system is moved along a visual axis, orthogonal to the x, y-plane of an x, y, z-coordinate system, to a target z-coordinate of a point to be measured on a surface of an object. A light intensity of light reflected by the surface is dependent on a distance of the focal point along the z-axis to the point to be measured, and is detected and used in determining the actual z-coordinate of the point to be measured by an evaluation device.

### RELATED APPLICATIONS

This application is the National Stage of International Application No. PCT/EP2012/067113, filed Sep. 3, 2012, which claims the benefit of German Patent Application No. DE 102011083421.4, filed Sep. 26, 2011. The entire contents of both documents are hereby incorporated herein by reference.

### TECHNICAL FIELD

The present teachings relate generally to measuring a homogeneous and reflective surface of an object positioned in an orthogonal x-, y-, z-coordinate system and, in some embodiments, to measuring a homogeneous and reflective curved surface of the object.

### BACKGROUND

Deflectometry has been used for measuring the shape of reflective surfaces but is relatively inaccurate.

Confocal measurement of the shapes of surfaces has been used for large objects depending on mirror curvature. A confocal measurement of the shape of a surface may be time-consuming. Moreover, conventional systems are relatively expensive. Conventional systems are unsuitable for use with strongly curved surfaces due to the large size of the associated optics. Due to the size of conventional optics, some parts of a surface to be measured may be inaccessible by a conventional sensor system.

### SUMMARY AND DESCRIPTION

The scope of the present invention is defined solely by the appended claims, and is not affected to any degree by the statements within this summary.

Surfaces to be measured may be curved (e.g., concavely or convexly). Measurement of curved surfaces (e.g., with geometric accuracy up to, for example, 10 μm) may be desirable. The surfaces may be homogeneous with regard to reflection coefficients of the surface.

The present embodiments may obviate one or more of the drawbacks or limitations in the related art. For example, in some embodiments, devices and methods for measuring homogeneous, reflective surfaces (e.g., curved) are provided that may produce an unlimited measurement range of a detected 2-variable, thereby producing a resolution in the micrometer and sub-micrometer ranges. By contrast to conventional systems, a device in accordance with the present teachings may be cost-effective and compact in design, with a small objective, and configured to execute a measurement quickly. In some embodiments, surfaces with slopes (e.g., large slopes) may be measured. Moreover, in some embodiments, surfaces may be measured completely.

In accordance with a first aspect, a method is provided for measuring a homogeneously reflective surface of an object positioned in an orthogonal x-, y-, z-coordinate system. The x-, y-, z-coordinates of a multiplicity of points on the surface of the object are measured point-by-point. A sensor system is provided that is configured for focusing light onto a focal point at known x-, y-, z-coordinates, and for measuring coordinates of a distance vector between a point to be measured and the focal point.

In accordance with a second aspect, a device is provided for measuring a homogeneously reflective surface of an object positioned in an orthogonal x-, y-, z-coordinate system. The x-, y-, z-coordinates of a multiplicity of points on the surface of the object are measured point-by-point. A sensor system is provided that is configured for focusing light onto a focal point at known x-, y-, z-coordinates, and for measuring coordinates of a distance vector between a point to be measured and the focal point.

The x-, y-, z-coordinates of a point to be measured may be determined by adding the coordinates of a distance vector to the known x-, y-, z-coordinates of the focal point.

In some embodiments, the sensor system may be a confocal sensor system that focuses light from a light source by a focusing device at a focal length in the direction of the surface onto a focal point on an optical axis. The x-, y-, z-coordinates of the focal point may be measured by measuring the three-dimensional position of the sensor system in the coordinate system using a length measuring device.

In some embodiments, the confocal sensor system may be adjusted with an adjusting device, such that the optical axis runs orthogonal to the x-, y-plane. The sensor system and the object may be adjusted relative to one another by a relative movement device, such that the optical axis runs through the point to be measured and the x-, y-coordinates of the focal point correspond to the x-, y-coordinates of the point to be measured.

In some embodiments, the confocal sensor system and the object may be adjusted relative to one another by the relative movement device, such that the z-coordinate of the focal point corresponds to a desired z-coordinate of the point to be measured. The desired z-coordinate may be determined from a model of the surface of the object.

In some embodiments, the confocal sensor system may detect a light intensity of light reflected by the surface by a detecting device. The light intensity is dependent on the z-coordinate of the focal point. The detected light intensity may be used by an evaluation device to determine the z-coordinate of the point to be measured. The z-value of the surface may be determined at a defined x-, y-position in the coordinate system.

In some embodiments, the z-coordinate of the focal point may be varied in the z-direction until the evaluation device assesses the detected light intensity as being a maximum and the z-coordinate of the focal point as corresponding to the z-coordinate of the point to be measured. In some embodiments, the evaluation device may assess the detected light intensity as being a maximum and the z-coordinate of the point to be measured as corresponding to the z-coordinate of the focal point using a previously determined light intensity profile dependent on the z-coordinate of the focal point. A measuring time interval may be thereby reduced.

In some embodiments, using a previously determined light intensity profile dependent on the z-coordinate of the focal point and two detected light intensities, the evaluation device may determine the z-coordinate of the point to be measured for two different z-coordinates of the focal point.

In some embodiments, using two different previously stored light intensity profiles of two detecting devices, the two different previously stored light intensity profiles being dependent on the z-coordinate of the focal point, and by using two detected light intensities, the evaluation device may determine the z-coordinate of the point to be measured for a z-coordinate of the focal point.

In some embodiments, the sensor system may additionally be a chromatic confocal distance sensor configured to measure a distance of the point to be measured from the sensor system in the z-direction along the optical axis. The distance and the z-coordinate of the point to be measured may be determined using a wavelength region of a detected maximum light intensity.

In some embodiments, the evaluation device may determine a slope of the surface at a point to be measured in the x- and/or y-direction using a detection, executed by the detecting device, of a displacement from an optical axis of a light intensity value detected at a slope of zero. The light intensity value is dependent on the z-coordinate of the focal point.

In some embodiments, the x- and y-coordinates of the point to be measured may be defined by a measurement point pattern in the x, y-plane.

In some embodiments, the measurement point pattern may have measurement points that are equidistant from one another at corners of grid squares.

In some embodiments, the z-coordinate of the focal point may be varied in the z-direction by a relative movement of the sensor of the sensor system and the object. The relative movement may be effected by the relative movement device.

In some embodiments, the z-coordinate of the focal point may be varied in the z-direction by varying the focal length using the focusing device.

In some embodiments, the length-measuring device may have a glass scale configured for measuring x-, y-, z-coordinate values.

In some embodiments, during measurement of a multiplicity of points, the x-, y-, z-coordinates of the focal point may be varied up to the end of a measurement period that is the same for each of the points to be measured. The evaluation device may determine the z-coordinate of the point to be measured, or at least an approximation thereof, by the detected light intensity values.

### BRIEF DESCRIPTION OF THE DRAWINGS

FIG. 1 shows a schematic illustration of a first exemplary measuring device.

FIG. 2 shows a first representative intensity profile from a first exemplary detecting device.

FIG. 3 shows a first exemplary surface profile to be measured.

FIG. 4 shows a second exemplary a surface profile to be measured.

FIG. 5 shows an example of a measured value profile.

FIG. 6 shows a second representative light intensity profile from a second exemplary detecting device.

FIG. 7 shows a third representative light intensity profile from a second exemplary measuring device.

FIG. 8 shows a representative plot for defining a maximum measurement period.

FIG. 9 shows a flow chart for an exemplary method in accordance with the present teachings.

FIG. 10 shows a schematic illustration of a second exemplary measuring device.

### DETAILED DESCRIPTION

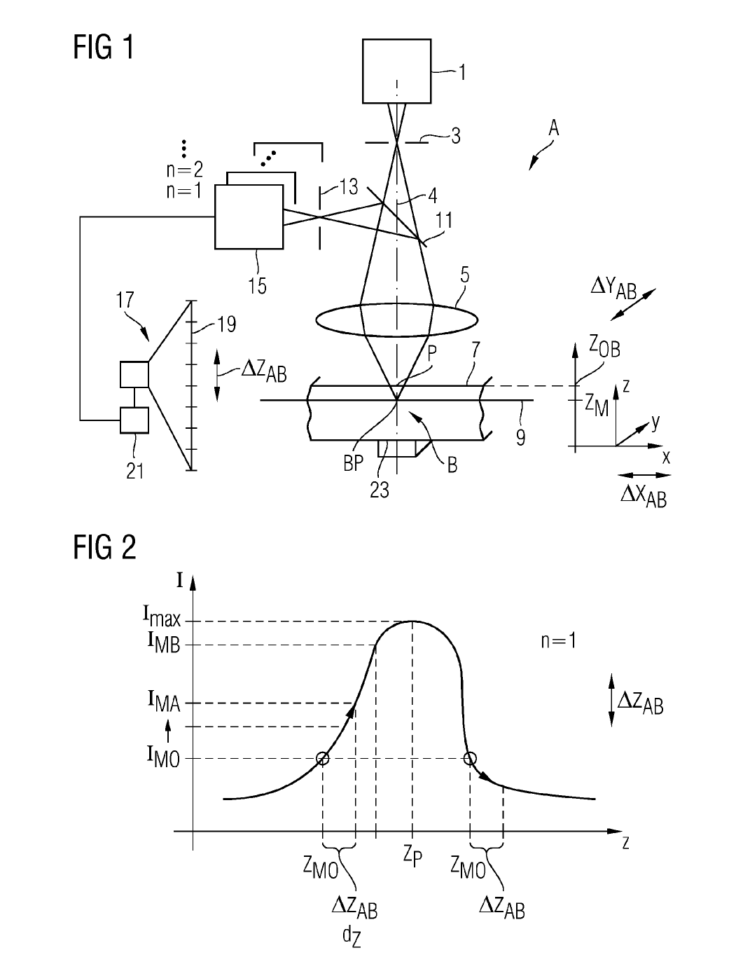

FIG. 1 shows a first exemplary embodiment of a measuring device in accordance with the present teachings. A homogeneously reflective surface 7 of an object B positioned in an orthogonal x-, y-, z-coordinate system is to be measured. FIG. 1 shows a confocal sensor system A wherein a light-emitting system and a light-detecting system are focused onto a common focal point BP. The confocal sensor system has a light source 1 that emits light in the direction of the surface 7 to be measured. The light may pass through a diaphragm 3 and be focused at the focal point BP by a focusing device 5. If the light is reflected at the focal point BP, the light may be detected using, for example, a beam splitter 11 in a detecting device 15. A diaphragm 13 configured for producing a defined beam profile may be placed upstream of the detecting device 15. The diaphragm 3 likewise effects a defined beam profile of the light source 1 along an optical axis 4 in the direction of the surface 7 to be measured of the object B, the object B being positioned in an orthogonal x-, y-, z-coordinate system. The light from the light source 1 is focused at known focal points having x-, y-, z-coordinates by the focusing device 5. The focusing device 5 may, for example, be an optical lens. The position of the light source 1 and the detecting system 15 may be interchanged. The focal point BP lies in a focal plane 9 that lies parallel to or in the x-, y-plane. The focal point BP lies on the optical axis 4 at a focal length of the focusing device 5. The position of the focal point BP in the confocal sensor system A may be thus determined. By measuring a position of the confocal sensor system A in the x-, y-, z-coordinate system using a length measuring device 17, the position of the focal point BP in the coordinate system may be measured. A length measurement may be executed, for example, using a glass scale. FIG. 1 shows a glass scale 19 configured for measuring the z-coordinate of the focal point in the coordinate system. If the sensor system A and the object B are moved relative to one another by a relative movement device 23, such that the light from the light source 1 is emitted along the optical axis 4 set orthogonal to the x-, y-plane in the direction of the surface 7, the detecting device 15 may detect a light intensity of the light reflected by the surface 7. In such embodiments, a detected intensity value for a homogeneously reflective surface depends on only the position of the focal point BP with reference to the surface 7. A distance vector of a point P to be measured on the surface 7 of the object B from a preset focal point BP may be determined by the sensor system A. When using the measured values provided by the length measuring device 17, an evaluation device 21 may determine the x-, y-, z-coordinates of a point P to be measured on the surface 7 of the object B using the light intensity values detected by the detecting device 15 and, if appropriate, further data stored in a storage device.

FIG. 1 shows an exemplary measurement system wherein a focal point BP is produced. The x-, y-, z-coordinates of the focal point BP may be varied and may, for example, be measured by the length-measuring device 17. In some embodiments, sensor systems that may have a plurality of detecting devices 15 are provided. The sensor systems may be used in parallel as shown, for example, by the multiplicity n of detecting devices 15 in FIG. 1.

FIG. 2 shows a first exemplary intensity profile as detected by an exemplary detecting device. As shown in FIG. 2, a profile of the light intensity I detected by the detecting device 15 is plotted as a function of the z-coordinate of the focal point BP that the light from the light source 1 is focused upon. The light is reflected into the detecting device 15 by the surface 7 of the object B. If the optical axis 4 of the focusing device 5 of the confocal sensor system A runs orthogonal to the x-, y-plane of the coordinate system (e.g., through the x-, y-coordinates of a point P to be measured on the surface 7), an intensity value I detected by the detecting device 15 for a homogeneously reflective surface depends on the z-coordinate of the focal point BP with reference to the z-coordinate of the point P to be measured. The intensity profile I(z) shows that the light intensity detected by the detecting device 15 is small when there is a large distance or distance vector between the focal point BP and the point P to be measured on the surface 7. If the focal point BP approaches the point 7 to be measured, the respective intensity value I detected by the detecting device 15 increases. The detected intensity value I is a maximum for a distance of zero (e.g., the focal point BP is produced at the point 7 to be measured). The intensity profile shown in FIG. 2 resembles a Gaussian curve. A z-coordinate of the point P to be measured may be determined with the aid of a known intensity profile I(z) that is, for example, measured in advance and stored in a storage device. For example, if the focal point BP is positioned at a coordinate Z_{M0} in a confocal sensor system, an associated intensity value I_{M0} is detected. The relationship of the focal point BP to the point P is still ambiguous at the first measurement position. The focal point BP may have a z-coordinate that is larger or smaller than that of the point P to be measured. As a result, a detected intensity I_{M0} may be assigned two z-coordinates of the point P. Thus, a second measurement may be performed wherein the focal point BP is shifted in the z-direction and a further intensity value I_{MA} is determined. As shown in FIG. 2, the z-coordinate Z_{M0} of the focal point BP is increased by ΔZ_{AB}. Since the measured intensity value I_{MA} is greater than I_{M0}, the z-coordinate Z_{P} of the point P to be measured on the surface 7 may be determined unambiguously based on the intensity profile I(z). Alternatively, if the intensity profile I(z) is not known, the z-coordinate of the focal point BP may be varied until a maximum intensity Iₘₐₓ has been determined. A plurality of additional measurements of intensity values (e.g., I_{MB}) may be made for this end. The double arrow shown to the right in FIG. 2 indicates that a relative variation in the z-coordinates of the focal point BP and the point P to be measured may be set to be wide (e.g., by a relative shift of the sensor system A and the object B along the z-axis).

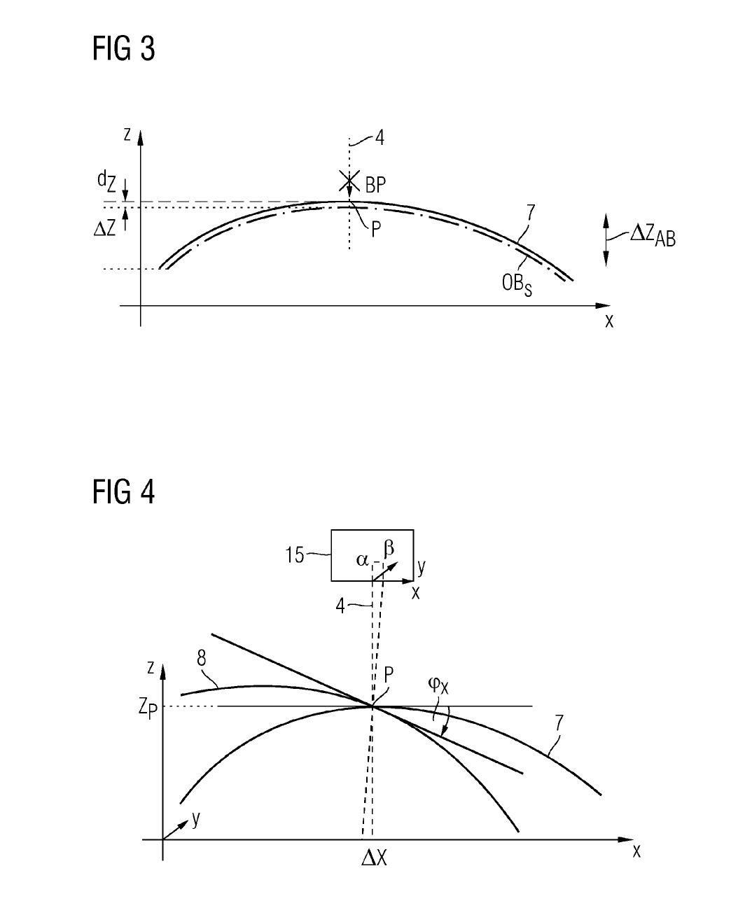

FIG. 3 shows a first exemplary surface profile to be measured. As shown in FIG. 3, a profile of the z-coordinates of a surface 7 to be measured is plotted as a function of the x-coordinates of the points P to be measured on the surface 7 of the object B. Surface profiles may be convex or concave, for example. A surface 7 to be measured may have inflection points. In the x-, z-plane, as shown in FIG. 3, a focal point BP is initially shifted on an optical axis 4 parallel to the z-axis at the x-, y-coordinate of the point P to be measured. The focal point BP is shifted into a z-coordinate value corresponding to a z-coordinate value of a desired surface OB_{S} of a given model of the object B. A relative movement of the sensor system A and the object B along the z-axis may be executed for the first positioning by a relative movement device 23. Because the focal point BP may be shifted as desired along the z-axis, the measurement range ΔZ of a device in accordance with the present teachings may likewise be set as desired. The device may resolve a difference d_{Z} in the z-coordinates of the focal point BP and the point P to be measured. The resolution is illustrated as d_{Z} in FIG. 3 and corresponds, for example, to a difference Z_{P}−Z_{M0}=d_{Z} in FIG. 2.

FIG. 4 shows a second exemplary surface profile for determining a slope at a point P to be measured on the surface 7. FIG. 4 shows the surface 7 of FIG. 3 in the x-, z-plane. The surface profile at the point P has a slope of zero. A detecting device 15 detects a light intensity value for a focal point BP that lies, for example, at the point P to be measured. If the surface 7 is tilted by a tilt angle φₓ, there is a change in the slope of the surface 7 at the point P. This change in slope is illustrated by the surface profile 8.

The intensity value detected on the surface 7 by the detecting device 15 is shifted according to the tilt angle c) as a result of the tilting movement. An evaluation device 21 may determine a slope of the surface 7 along the x- and/or y-axis for each point P to be measured. The slope may be determined based on detection by the detecting device 15 of a shift of a light intensity value I(z) detected for a slope of zero from the optical axis in a position a into a position 13. The light intensity value is dependent on the z-coordinate of the focal point BP. The evaluation device 21 may assign the slope for the point P to the shift of the light intensity value I(z) using previously determined intensity profiles as a function of slope changes of the surface 7 at a fixed point. The procedure described above in reference to FIG. 4 is likewise valid for use in the y-, z-plane.

FIG. 5 shows a scanning signal wherein measurements of z-coordinate values z,), and tilt angles c) and (p), are executed for a multiplicity of pointwise scanned points P to be measured on a surface 7 of an object B. The surface 7 may be be scanned or measured point-wise when the respective measurement period T_{M} is constant, thereby facilitating processing of the measured values. Furthermore, in order to reduce the measurement period for measuring the entire surface 7, the x-, y-coordinates of each of the points P to be measured may be fixed by a measurement point pattern in the x-, y-plane. In some embodiments, a measurement point pattern has measurement points equally spaced from one another (e.g., at corners of grid squares).

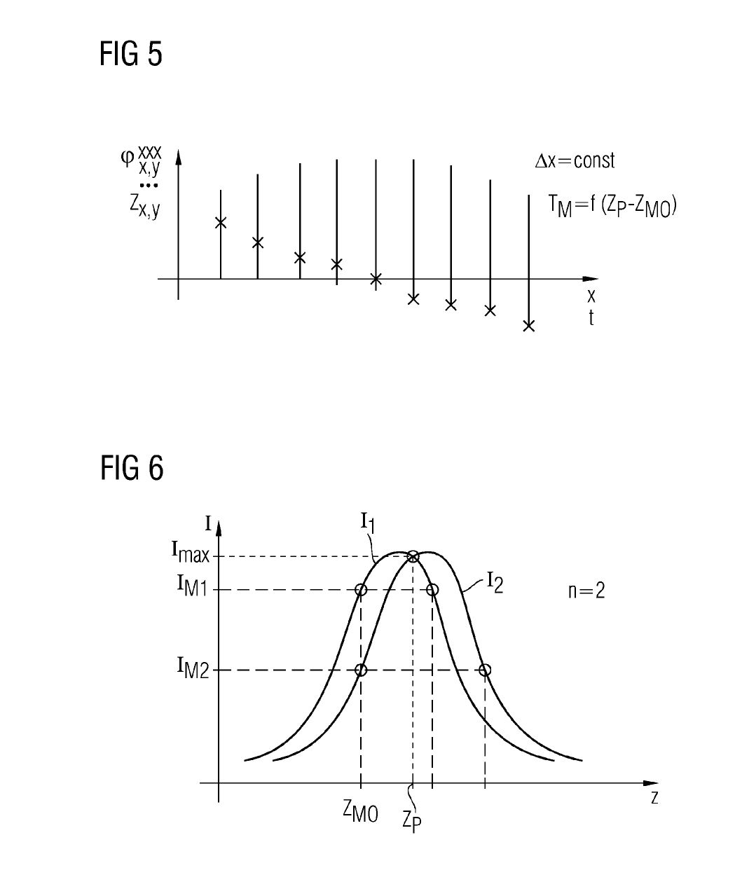

FIG. 6 shows a second exemplary light intensity profile of a confocal sensor system A. The confocal sensor system A is configured as a bifocal sensor system wherein a number n =2 of detecting devices 15 are used. Each of the two detecting devices has a mutually different light intensity profile I₁ and I₂, respectively. The light intensity profiles I₁ and I₂ of the detecting device 15 are dependent on the z-coordinate of the focal point BP and are stored in advance in the evaluation unit 21 in a storage device. For a single measurement position of the focal point BP, the intensity profiles I₁ and I₂ may be used to simultaneously detect two light intensity values I_{M1} and I_{M2}. The z-coordinate Z_{P} of the point P to be measured may be determined therefrom. The z-coordinate Z_{P} may be unambiguously determined for the single measurement position.

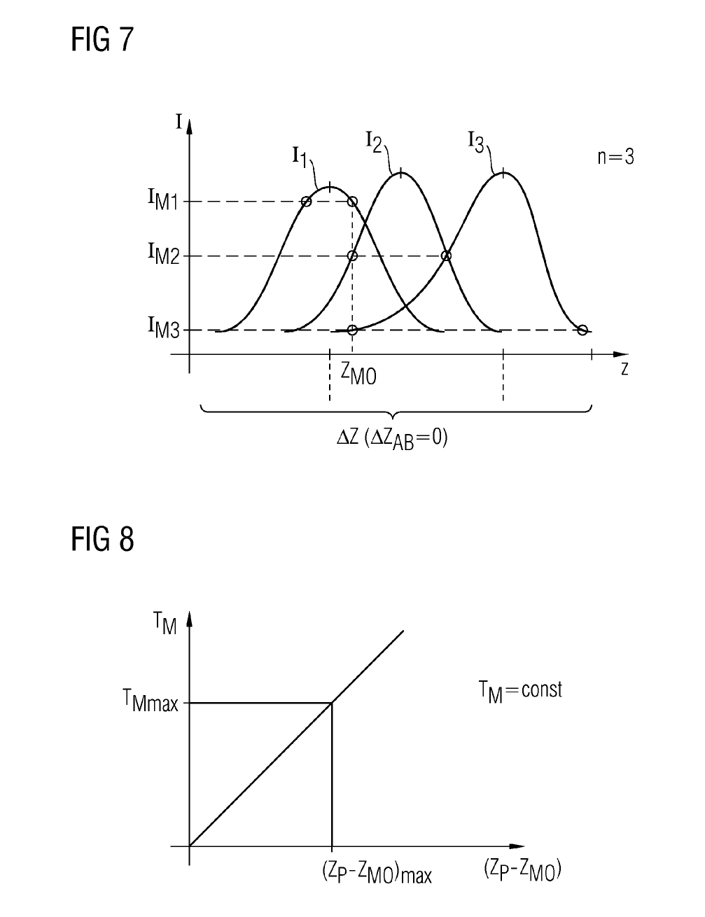

FIG. 7 shows a third exemplary light intensity profile of a confocal sensor system A. The confocal sensor system A is configured as a sensor system wherein a number n =3 of detecting devices 15 are used. Each of the detecting devices has a mutually differing light intensity profile I_{I}, I₂, and I₃, respectively. Such a superposition of light intensity profiles I₁, I₂, and I₃ may result, for example, when the detecting devices 15 respectively detect different wavelength regions of the light emitted by the light source 1. The focal point BP is shifted with regard to the z-coordinate in accordance with a respective detected wavelength. In other words, if the original focal point BP is shifted to the z-coordinate Z_{MO}, the detecting devices 15 detect an intensity value I_{M1} for a first wavelength region, an intensity value I_{M2} for a second wavelength region, and an intensity value I_{M3} for a third wavelength region. The measured intensity values and the known intensity profiles may be used to determine the z-coordinate Z_{P} of the point P in a simple way, and to increase a measurement range ΔZ and a resolution d_{Z}. With the above-described sensor system, a relative movement of the sensor system A and the object B to determine a distance vector between the focal point and the point P to be measured may be avoided.

FIG. 8 shows a plot of a measurement period T_{M} for determining the x-, y-, z-coordinates of a point P to be measured on a surface 7 of an object B versus the difference of the z-coordinate Z_{P} of the point P relative to the first measurement position of the focal point BP at the z-coordinate Z_{M0}. The measurement period T_{M} is directly proportional to the distance between the first measurement position of the focal point BP and the position of the point P to be measured. The distance vector and, therefore, the measuring time T_{M} may already be effectively reduced by a correspondence of the first measurement position of the focal point BP in the z-coordinate Z_{MO} to a position in a desired z-coordinate Z_{P}-desired. Such values may be determined from a model of the surface 7 of the object B. Furthermore, a surface 7 to be measured may be measured and scanned with the aid of a scanning signal. An equal constant period may be fixed between each scan. In order to simplify the processing of the measured values for a multiplicity of points P, the x-, y-, z-coordinates of a focal point BP may be changed up to the end of a measurement period T_{Mmax} that is the same for each of the points P to be measured. The evaluation unit 21 determines the z-coordinate of the point P, or at least an approximation thereof, using the detected light intensity values I(z).

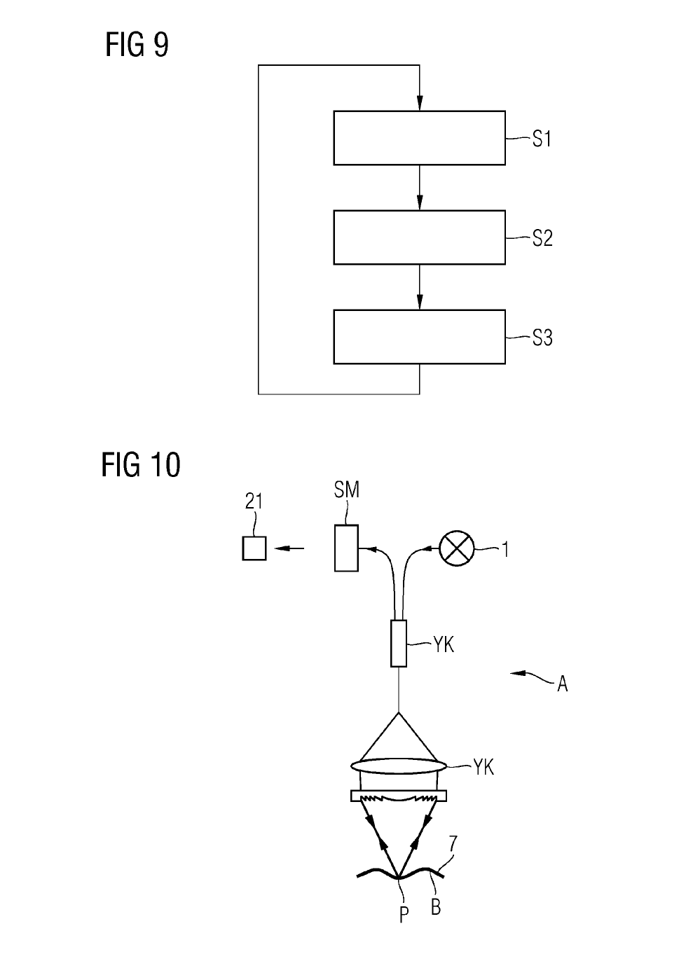

FIG. 9 shows a flow chart for an exemplary method in accordance with the present teachings. A confocal sensor system A is used to measure shape. Exemplary embodiments of a confocal sensor system A are shown in FIGS. 1 and 10. Such sensor systems are configured to measure whether an approaching point P on a surface 7 to be measured is at the focal point BP. If the point P is not at the focal point BP, a measurement is made as to the directions wherein the surface 7 is to be measured, and the sensor system A is to be moved so that the point P to be measured of the surface 7 will be at the focal point BP. The focus sensor system may provide a sufficiently accurate position of a focal point BP in the micrometer and/or sub-micrometer range. In act 51 shown in FIG. 9, the x- and y-positions of the point P to be measured on the surface 7 are approached using the highly accurate x-, y-axes. The z-position of a focal point BP is moved in act S2 using a highly accurate z-axis with a highly accurate measurement system (e.g., a glass scale). In act S3, a determination is made that the focal point BP is at the point P to be measured on the surface 7. The x-, y-, and z-position values are read and stored by the glass scales. The highly accurate measurements may be carried out using a glass scale that provides quick readings. In order to measure the entire surface, the confocal focus sensor system A is moved in the x- and/or y-directions relative to the surface 7 that is measured. The z-axis is adjusted such that a point P to be measured is at the focal point BP of the focus sensor.

FIG. 10 shows a second exemplary device in accordance with the present teachings. FIG. 10 shows a chromatic confocal distance sensor. Light emanating from a light source 1 is directed via a y-coupler YK and a sensor head SK onto an object B. The retro-reflected light is detected in a spectrometer SM and evaluated by an evaluation device 21. A point P on a reflective surface 7 of an object B may be measured using the chromatic confocal sensor system A shown in FIG. 10. In addition, a device in accordance with FIG. 1 having one or more detecting devices 15, each detecting device 15 being assigned, respectively, its own intensity profile I(z), may be combined with a device in accordance with FIG. 10 and used for measurement.

While the present invention has been described above by reference to various embodiments, it should be understood that many changes and modifications may be made to the described embodiments. It is therefore intended that the foregoing description be regarded as illustrative rather than limiting, and that it be understood that all equivalents and/or combinations of embodiments are intended to be included in this description.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding claim whether independent or dependent and that such new combinations are to be understood as forming a part of the present specification.

1. A method for measuring a homogeneously reflective surface of an object positioned in an orthogonal x-, y-, z-coordinate system, the method comprising:
measuring, point-by-point, x-, y-, z-coordinates for a multiplicity of points on the surface of the object;
focusing, via a sensor system, light onto a focal point at known x-, y-, z-coordinates; and
measuring coordinates of a distance vector between a point to be measured and the focal point.

2. The method of claim 1, wherein the sensor system comprises a confocal sensor system configured to focus light from a light source through a focusing device at a focal length in a direction of the surface onto a focal point on an optical axis, and wherein the method further comprises measuring x-, y-, z-coordinates of the focal point and measuring, by a length measuring device, a three-dimensional position of the sensor system in the x-, y-, z-coordinate system.

3. The method of claim 2, further comprising:
adjusting the confocal sensor system with an adjusting device, such that the optical axis runs orthogonal to an x-, y-plane; and
adjusting the sensor system and the object relative to one another with a relative movement device, such that the optical axis runs through the point to be measured and x-, y-coordinates of the focal point correspond to x-, y-coordinates of the point to be measured.

4. The method of claim 3, further comprising adjusting the confocal sensor system and the object relative to one another with the relative movement device, such that the z-coordinate of the focal point corresponds to a z-coordinate of the point to be measured.

5. The method of claim 3, further comprising:
detecting, with a detecting device, a light intensity of light reflected by the surface, the light intensity being dependent on the z-coordinate of the focal point; and
determining, by an evaluation device, a z-coordinate of the point to be measured.

6. The method of claim 5, further comprising varying the z-coordinate of the focal point in a z-direction until the evaluation device assesses the detected light intensity as being a maximum and the z-coordinate of the focal point as corresponding to the z-coordinate of the point to be measured.

7. The method as claimed in claim 5, wherein the evaluation device assesses the detected light intensity as being a maximum and the z-coordinate of the point to be measured as corresponding to the z-coordinate of the focal point using a previously determined light intensity profile dependent on the z-coordinate of the focal point.

8. The method of claim 5, wherein the evaluation device determines the z-coordinate of the point to be measured for two different z-coordinates of the focal point using a previously determined light intensity profile (I(z)) dependent on the z-coordinate of the focal point and two detected light intensities.

9. The method of claim 5, wherein the evaluation device determines the z-coordinate of the point to be measured for a z-coordinate of the focal point using two different previously stored light intensity profiles of two detecting devices, the light intensity profiles being dependent on the z-coordinate of the focal point and two detected light intensities.

10. The method of claim 5, wherein the sensor system comprises a chromatic confocal distance sensor configured to measure a distance of the point to be measured from the sensor system along the optical axis in a z-direction, and wherein the method further comprises determining the distance and the z-coordinate of the point to be measured using a wavelength region of a detected maximum light intensity.

11. The method of claim 5, wherein the evaluation device is configured to determine a slope of the surface at the point to be measured in, an x-direction, a y-direction, or the x-direction and the y-direction based on a detection by the detecting device, of a displacement from the optical axis of a light intensity value detected at a slope of zero, the light intensity value being dependent on the z-coordinate of the focal point.

12. The method of claim 3, wherein the x-, y-coordinates of the point to be measured are defined by a measurement point pattern in the x-, y-plane.

13. The method of claim 12, wherein the measurement point pattern comprises equidistant measurement points.

14. The method of claim 5, further comprising varying the z-coordinate of the focal point in a z-direction by using the relative movement device to effect a relative movement between the sensor system and the object.

15. The method of claim 5, further comprising varying the z-coordinate of the focal point in a z-direction by using the focusing device to vary the focal length.

16. The method of claim 2, wherein the length measuring device comprises a glass scale configured to measure x-, y-, z-coordinate values.

17. The method of claim 7, further comprising:
varying, in a measurement period, the x-, y-, z-coordinates of the focal point during measurement of a multiplicity of points. the measurement period being the same for each of the points to be measured; wherein
the evaluation device is configured to determine the z-coordinate of the point to be measured, or an approximation thereof, using the detected light intensity values.

18. A device for measuring a homogeneously reflective surface of an object positioned in an orthogonal x-, y-, z-coordinate system, the device comprising:
a sensor system configured to focus light onto a focal point at known x-, y-, z-coordinates;
wherein the device is configured to measure, point-by-point, x-, y-, z-coordinates for a multiplicity of points on the surface of the object; and
wherein the device is further configured to measure coordinates of a distance vector between a point to be measured and the focal point.

19. The device of claim 18, wherein the sensor system comprises a confocal sensor system configured to focus light from a light source through a focusing device at a focal length in a direction of the surface onto a focal point on an optical axis, wherein the device is further configured to measure x-, y-, z-coordinates of the focal point, and wherein the device further comprises a length measuring device configured to measure a three-dimensional position of the sensor system in the x-, y-, z-coordinate system.

20. The device of claim 19, further comprising:
an adjusting device configured to adjust the confocal sensor system, such that the optical axis runs orthogonal to n x-, y-plane; and
a relative movement device configured to adjust the sensor system and the object relative to one another, such that the optical axis runs through the point to be measured and x-, y-coordinates of the focal point correspond to x-, y-coordinates of the point to be measured.

21. The device of claim 20, wherein the relative movement device is further configured to adjust the confocal sensor system and the object relative to one another, such that the z-coordinate of the focal point corresponds to a z-coordinate of the point to be measured.

22. The device of claim 20, further comprising:
a detecting device configured to detect a light intensity of light reflected by the surface, the light intensity being dependent on the z-coordinate of the focal point; and
an evaluation device configured to determine a z-coordinate of the point to be measured.

23. The device of claim 22, wherein the evaluation device is further configured to assess the detected light intensity as being a maximum and the z-coordinate of the focal point as corresponding to the z-coordinate of the point to be measured when the z-coordinate of the focal point is varied in a z-direction.

24. The device of claim 22, wherein the evaluation device is further configured to assess the detected light intensity as being a maximum and the z-coordinate of the point to be measured as corresponding to the z-coordinate of the focal point using a previously determined light intensity profile dependent on the z-coordinate of the focal point.

25. The device of claim 22, wherein the evaluation device is further configured to determine the z-coordinate of the point to be measured for two different z-coordinates of the focal point using a previously determined light intensity profile dependent on the z-coordinate of the focal point and two detected light intensities.

26. The device of claim 22, wherein the evaluation device is further configured to determine the z-coordinate of the point to be measured for a z-coordinate of the focal point using two different previously stored light intensity profiles of two detecting devices, the light intensity profiles being dependent on the z-coordinate of the focal point, and two detected light intensities.

27. The device of claim 22, wherein the sensor system comprises a chromatic confocal distance sensor configured to measure a distance of the point to be measured from the sensor system along the optical axis in a z-direction.

28. The device of claim 22, wherein the evaluation device is further configured to determine a slope of the surface at the point to be measured in an x-direction, a y-direction, or the x-direction and the y-direction based on a detection by the detecting device, of a displacement from the optical axis of a light intensity value detected at a slope of zero, the light intensity value being dependent on the z-coordinate of the focal point.

29. The device of claim 20, wherein the x-, y-coordinates of the point to be measured are defined by a measurement point pattern in the x-, y-plane.

30. The device of claim 29, wherein the measurement point pattern comprises equidistant measurement points.

31. The device of claim 22, wherein the relative movement device is further configured to effect a relative movement between the sensor system and the object to vary the z-coordinate of the focal point in a z-direction.

32. The device of claim 22, wherein the focusing device is configured for varying the focal length to vary the z-coordinate of the focal point in a z-direction.

33. The device of claim 19, wherein the length measuring device comprises a glass scale configured to measure x-, y-, z-coordinate values.

34. The device of claim 24, wherein the device is configured to vary, in a measurement period, the x-, y-, z-coordinates of the focal point the measurement period being the same for each of the points to be measured, and wherein the evaluation device is further configured to determine the z-coordinate of the point to be measured, or an approximation thereof, using the detected light intensity values.
